(19) United States
(12) Patent Application Publication
(10) Pub. No.: US 2023/0171384 A1
(43) Pub. Date: Jun. 1, 2023

(54) PROJECTION SYSTEM AND METHOD OF CONTROLLING PROJECTION SYSTEM

(71) Applicant: SEIKO EPSON CORPORATION, Tokyo (JP)

(72) Inventor: Eiji MORIKUNI, Matsumoto-shi (JP)

(73) Assignee: SEIKO EPSON CORPORATION, Tokyo (JP)

(21) Appl. No.: 17/994,926

(22) Filed: Nov. 28, 2022

(30) Foreign Application Priority Data
Nov. 29, 2021 (JP) 2021-192747

(51) Int. Cl. H04N 9/31; G06F 3/042; G06T 1/00

(52) U.S. Cl. CPC H04N 9/3179; G06F 3/0425; G06T 1/0007

(57) ABSTRACT

In a projection system including a projector and a display device, the projector receives an image from the display device, projects the received image to a projection target, captures the range including the projection target, and transmits the captured image to the display device, and the display device generates a drawing image based on a drawing operation, displays the drawing image on a display, transmits the drawing image to the projector, receives the captured image from the projector, and performs processing of removing an image overlapping the captured image received from the projector from the drawing image displayed on the display so as to update the display of the display based on the captured image and the processed image.

The present application is based on, and claims priority from JP Application Serial Number 2021-192747, filed Nov. 29, 2021, the disclosure of which is hereby incorporated by reference herein in its entirety.

### BACKGROUND

### 1. Technical Field

The present disclosure relates to a projection system and a method of controlling the projection system.

### 2. Related Art

In the related art, a technique is known that draws, in a superimposed manner, letters and the like on an image projected or displayed by a projector. For example, the device disclosed in JP-A-2015-161748 enables handwriting of letters in a superimposed manner on an image projected on a screen. This device can record data of handwriting letters in a recording medium in association with projected image data, and play the image data and the handwriting letters in a superimposed manner.

In the related art, a state where an image such as a projection image of a projector and handwriting letters and the like are superimposed cannot be easily shared between a plurality of devices.

### SUMMARY

A projection system of an aspect of the present disclosure includes a projector and a display device. The projector includes a projector communication unit configured to communicate with the display device, a projection unit configured to project an image to a projection target, an image-capturing unit configured to capture a range including the projection target. The projector projects, using the projection unit, an image received by the projector communication unit, and transmits, using the projector communication unit, a captured image captured by the image-capturing unit. The display device includes a display communication unit configured to communicate with the projector, a display configured to display an image, and an operation unit configured to accept a drawing operation. The display device generates a drawing image based on the drawing operation accepted by the operation unit, displays the drawing image on the display, transmits the drawing image to the projector communication unit by using the display communication unit, receives the captured image by using the display communication unit, and performs processing of removing, from the drawing image displayed on the display, an image overlapping the captured image received from the projector, and updates display on the display based on the captured image and the processed image.

A method according to another aspect of the present disclosure is a method of controlling a projection system including a projector and a display device, the method including, by the projector, receiving an image from the display device, projecting the image received to a projection target, capturing a range including the projection target, and transmitting a captured image captured to the display device, the method including, by the display device, generating a drawing image based on a drawing operation, displaying the drawing image on a display, transmitting the drawing image to the projector, receiving the captured image from the projector, and performing processing of removing an image overlapping the captured image received from the projector from the drawing image displayed on the display, to update display on the display based on the captured image and the processed image.

### BRIEF DESCRIPTION OF THE DRAWINGS

FIG. 1 is a diagram illustrating a schematic configuration of a projection system of an embodiment.

FIG. 2 is a block diagram of each device of the projection system of the embodiment.

FIG. 3 is a schematic view illustrating exemplary configurations of a projection unit and an image-capturing unit.

FIG. 4 is a schematic view illustrating other exemplary configurations of the projection unit and the image-capturing unit.

FIG. 5 is a sequence diagram illustrating an operation of the projection system of the embodiment.

FIG. 6 is a sequence diagram illustrating an operation of the projection system of the embodiment.

FIG. 7 is a schematic view of an operation of the projection system of the embodiment.

### DESCRIPTION OF EXEMPLARY EMBODIMENTS

### 1. Configuration of Projection System

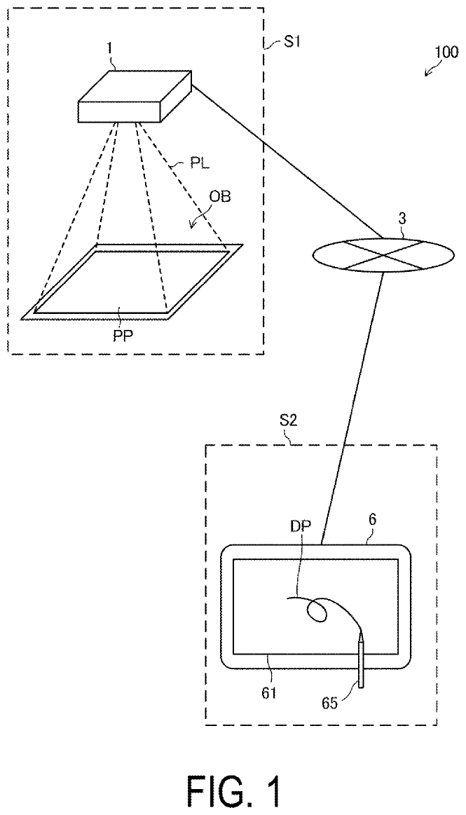

FIG. 1 is a diagram illustrating a schematic configuration of a projection system 100 according to the embodiment. The projection system 100 includes a projector 1 and a display device 6. The projector 1 and the display device 6 are connected with each other through a communication network 3 in such a manner as to enable mutual data communication.

Installation locations of the projector 1 and the display device 6 are not limited, and a use location S1 of the projector 1 and a use location S2 of the display device 6 may be separated from each other or adjacent to each other, for example.

The communication network 3 is a network that enables data communication between devices. The communication network 3 may be a local network such as a local area network (LAN) and a wide area network, for example. In addition, the communication network 3 may be an open network such as the Internet, for example. The communication network 3 may be configured to include communication lines such as a dedicated line, a public network, and a cellular communication line, and communication devices such as a router and a gateway device. The projector 1 and the communication network 3 may be connected with each other in a wired manner through a communication cable or in a wireless manner through a radio communication channel. Likewise, the display device 6 and the communication network 3 may be connected with each other in a wired manner through a communication cable or in a wireless manner through a radio communication channel. The communication cable is a LAN cable or a USB cable compatible with universal serial bus (USB) communication standard, for example. The radio communication channel is configured of Wi-Fi, Bluetooth or the like, for example. Wi-Fi is a registered trademark. Bluetooth is a registered trademark.

The projector 1 forms a projection image PP on a projection target OB by projecting image light PL toward the projection target OB. The projection of the image light PL at the projector 1 corresponds to displaying the projection image PP on the projection target OB. In the following description, an image includes a video and a still image.

FIG. 1 illustrates a configuration in which the projector 1 is disposed above the projection target OB and the image light PL is projected downward from the projector 1, but this an example. The projection target OB may be a flat surface, or a surface with curvature or irregularity. The position of the projector 1 and the orientation of the projector 1 are set on the basis of the positional relationship with the projection target OB. For example, the projector 1 may be installed in an orientation for horizontally projecting the image light PL, or in an orientation for upwardly projecting the image light PL.

As described later, the projector 1 has a function of capturing the projection target OB. The projector 1 transmits a captured image obtained by capturing the projection target OB to the display device 6 through the communication network 3.

The display device 6 is a device including a display 61. It suffices that the display device 6 is a device having the display 61, an input function and a communication function. For example, the display device 6 is composed of a tablet computer, a laptop computer, or a smartphone. The display device 6 described in the present embodiment has a function of detecting an operation of an instructing member 65 on the display 61 and drawing a drawing image DP on the basis of the operation of the instructing member 65. The instructing member 65 is a pen-type device as illustrated in FIG. 1. The display device 6 may be configured to be able to use the user's fingers as the instructing member 65.

### 2. Configurations of Projector and Display Device

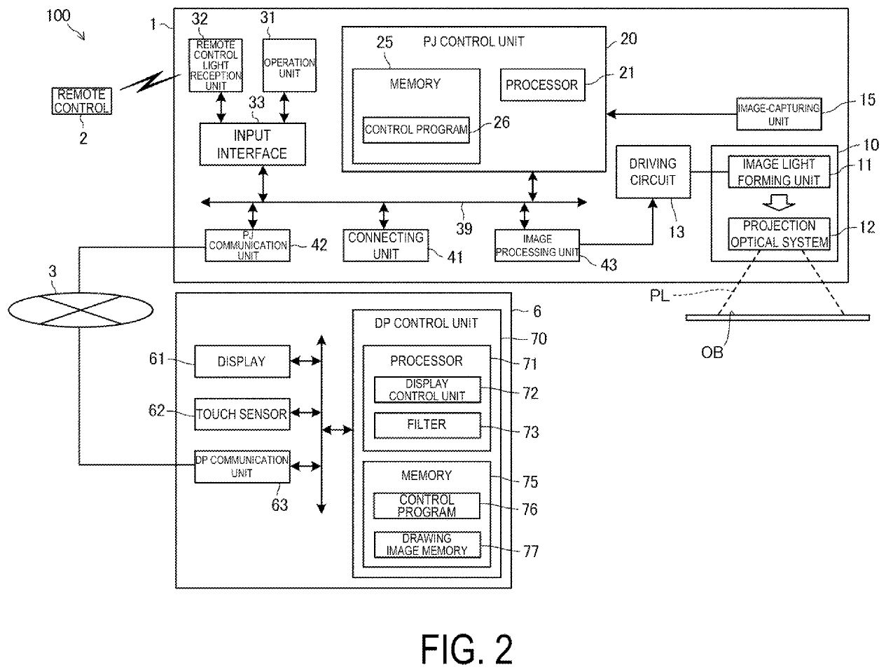

FIG. 2 is a block diagram of each device of the projection system 100.

The projector 1 includes a projection unit 10 that projects the image light PL and a driving circuit 13 that drives the projection unit 10. The projection unit 10 includes an image light forming unit 11 and a projection optical system 12.

The image light forming unit 11 generates the image light PL. The image light forming unit 11 includes a self-luminous element that emits light of predetermined colors. The light of predetermined colors is red light, blue light, and green light, for example. The self-luminous element may be a light emitting diode (LED) element, or an organic LED (OLED) element, for example. The configuration of the image light forming unit 11 is described later.

The image light forming unit 11 may include a light source including a lamp or a solid light source, and a light modulating device that modulates the light emitted by the light source, for example. Examples of the lamp include a halogen lamp, a xenon lamp, and a super-high-pressure mercury lamp. Examples of the solid light source include an LED and a laser light source. Examples of the light modulating device include a transmission type liquid crystal panel, a reflection type liquid crystal panel, and a digital micromirror device (DMD).

The projection optical system 12 includes an optical element that guides, toward the projection target OB, the image light PL emitted by the image light forming unit 11. The optical element includes a lens group including a plurality of lenses or one lens. The optical element may include a prism and a dichroic mirror. In addition, the optical element may include a reflective optical element such as a mirror.

The driving circuit 13 is connected to an image processing unit 43 described later. The driving circuit 13 forms the image light PL by driving the image light forming unit 11 on the basis of an image signal input from the image processing unit 43. For example, the driving circuit 13 forms images in a frame unit with the image light forming unit 11.

The projector 1 includes an image-capturing unit 15. The image-capturing unit 15 is a digital camera including an imaging element. The image-capturing unit 15 performs image-capturing under the control of a PJ control unit 20 described later, and outputs the captured image to the PJ control unit 20. The image-capturing range of the image-capturing unit 15 includes the direction in which the projection unit 10 projects the image light PL. For example, the image-capturing range of the image-capturing unit 15 includes the projection target OB. The imaging element provided in the image-capturing unit 15 is, for example, a complementary metal oxide semiconductor (CMOS) image sensor or a charge coupled device (CCD) image sensor. The configuration of the image-capturing unit 15 will be described later together with the projection unit 10.

The projector 1 includes a projector control unit 20, an operation unit 31, a remote control light reception unit 32, an input interface 33, a connecting unit 41, a projector communication unit 42, and the image processing unit 43. In the following description and drawings, the projector may be abbreviated as PJ. For example, the projector control unit 20 is referred to as PJ control unit 20, and the projector communication unit 42 is referred to as PJ communication unit 42. The PJ control unit 20, the input interface 33, the connecting unit 41, the PJ communication unit 42, and the image processing unit 43 are connected to each other through a bus 39 in such a manner as to enable mutual data communication.

The operation unit 31 includes various buttons and switches provided at the housing surface of the projector 1. The operation unit 31 generates an operation signal in accordance with the operation of buttons or switches, and outputs it to the input interface 33. The input interface 33 includes a circuit that outputs, to the PJ control unit 20, the operation signal input from the operation unit 31.

The remote control light reception unit 32 includes a light reception element that receives infrared light, and receives an infrared ray signal transmitted from a remote control 2. When a switch (not illustrated in the drawing) of the remote control 2 is operated, the remote control 2 transmits an infrared ray signal representing the operation. The remote control light reception unit 32 generates an operation signal by decoding the received infrared ray signal. The remote control light reception unit 32 outputs the generated operation signal to the input interface 33. The input interface 33 includes a circuit that outputs, to the PJ control unit 20, the operation signal input from the remote control light reception unit 32.

The specific configuration of transmitting and receiving the signal between the remote control 2 and the remote control light reception unit 32 is not limited. The configuration in which the remote control 2 transmits the infrared ray signal to the remote control light reception unit 32 is an example. For example, it is also possible to adopt a configuration in which a signal is transmitted and received between the remote control 2 and the remote control light reception unit 32 through a short-range wireless communication such as Bluetooth.

The connecting unit 41 is an interface device that receives image data from an external device. The connecting unit 41 is connected to players and personal computers that play optical disc-type storage media, for example.

The PJ communication unit 42 is connected to the communication network 3, and transmits and receives image data with the display device 6 through the communication network 3. The PJ communication unit 42 is a communication device including a connector that connects the communication cable and a communication circuit that inputs and outputs signals through the communication cable, for example. In addition, the PJ communication unit 42 may be a radio communication device. In this case, the PJ communication unit 42 includes an antenna, a radio frequency (RF) circuit, a baseband circuit and the like, for example.

The image processing unit 43 selects the image source under the control of the PJ control unit 20. The source that can be used by the projector 1 is image data received at the connecting unit 41 and image data received at the PJ communication unit 42, for example.

The image processing unit 43 performs image processing on the image data of the selected source under the control of the PJ control unit 20. The image processing performed by the image processing unit 43 is resolution conversion processing, geometric correction processing, digital zoom processing, image correction processing for adjusting the image tint and luminance and the like, for example.

The image processing unit 43 generates an image signal on the basis of the image data after the image processing and outputs it to the driving circuit 13. A frame memory not illustrated in the drawing may be connected to the image processing unit 43. In this case, the image processing unit 43 loads the image data acquired from the source in the frame memory. The image processing unit 43 performs the image processing on the image data loaded in the frame memory.

The image processing unit 43 may be composed of an integrated circuit, for example. The integrated circuit is composed of a large scale integration (LSI), for example. To be more specific, the image processing unit 43 is composed of an application specific integrated circuit (ASIC), a programmable logic device (PLD) and the like. The PLD includes a field programmable gate array (FPGA), for example. In addition, a part of the configuration of the integrated circuit may include an analog circuit and may be a combination of a processor and an integrated circuit. The combination of a processor and an integrated circuit is called micro controller (MCU), system-on-a-chip (SoC), system LSI, chip set or the like.

The PJ control unit 20 includes a processor 21 and a memory 25. The memory 25 is storage device that stores, in a non-volatile manner, data and programs to be executed by the processor 21. The memory 25 is composed of a magnetic storage device, a semiconductor memory element such as a flash read only memory (ROM), or other nonvolatile storage devices. The memory 25 may include a random access memory (RAM) making up the work area of the processor 21. The memory 25 stores data to be processed by the processor 21 and a control program 26 to be executed by the processor 21.

The processor 21 is composed of a central processing unit (CPU), a micro-processing unit (MPU) or the like. The processor 21 may be composed of a single processor or may have a configuration in which a plurality of processors function as the processor 21. The processor 21 may be composed of an SoC integrated with a part or all of the memory 25 and/or another circuit. In addition, as described above, the processor 21 may be composed of a combination of a CPU that executes programs, and a digital signal processor (DSP) that executes a predetermined arithmetic processing. All functions of the processor 21 may be installed in the hardware or may be configured using a programmable device. In addition, the processor 21 may also serve the function of the image processing unit 43. That is, the function of the image processing unit 43 may be executed by the processor 21.

The processor 21 controls each unit of the projector 1 by executing the control program 26 stored in the memory 25.

The processor 21 causes the image processing unit 43 to select the source and causes the image processing unit 43 to acquire the image data of the selected source. The processor 21 controls the driving circuit 13 to cause the projection unit 10 to project the image light PL and display the image on the basis of the image signal output by the image processing unit 43. In the operation of the projector 1 described below, the processor 21 causes the projection unit 10 to project the image received from the display device 6 with the PJ communication unit 42.

The processor 21 controls the image-capturing unit 15 so as to capture the range including the projection target OB. With the PJ communication unit 42, the processor 21 transmits the captured image of the image-capturing unit 15 to the display device 6.

The display device 6 includes the display 61, a touch sensor 62, a display communication unit 63 and a display control unit 70. In the following description and drawings, the display may be abbreviated as DP. For example, the display communication unit 63 is referred to as DP communication unit 63, and the display control unit 70 is referred to as DP control unit 70.

The display 61 displays images under the control of the DP control unit 70. The display 61 includes a liquid crystal display panel, an organic EL display panel, or other display panels, for example.

The touch sensor 62 detects an operation on the display panel of the display 61. The touch sensor 62 detects a contact operation or a press operation on the display 61 and outputs a signal representing the operation position to the DP control unit 70. The touch sensor 62 is composed of a pressure-sensitive sensor, a resistance film sensor, or a capacitive sensor, for example. In addition, the touch sensor 62 may be configured to detect the operation by performing radio communication with the instructing member 65. The touch sensor 62 may be configured to detect the operation at one position on the display panel of the display 61 or configured to be able to simultaneously detect the operations at a plurality of positions on the display panel. The touch sensor 62 is an example of the operation unit.

The DP communication unit 63 is connected to the communication network 3, and transmits and receives data to and from the projector 1 through the communication network 3. The DP communication unit 63 is a communication device including a connector that connects the communication cable and a communication circuit that inputs and outputs signals through the communication cable. In addition, the DP communication unit 63 may be a radio communication device. In this case, the DP communication unit 63 includes an antenna, an RF circuit, a baseband circuit and the like, for example.

The DP control unit 70 includes a processor 71 and a memory 75. The memory 75 is a storage device that stores, in a non-volatile manner, data and programs to be executed by the processor 71. The memory 75 is composed of a magnetic storage device, a semiconductor memory element such as a flash ROM, or other nonvolatile storage devices. The memory 75 may include a RAM making up the work area of the processor 71. The memory 75 stores data to be processed by the processor 71 and a control program 76 to be executed by the processor 71.

The processor 71 is composed of a CPU, an MPU or the like. The processor 71 may be composed of a single processor or may have a configuration in which a plurality of processors function as the processor 71. The processor 71 may be composed of an SoC integrated with a part or all of the memory 75 and/or another circuit. In addition, as described above, the processor 71 may be composed of a combination of a CPU that executes programs and a DSP that executes a predetermined arithmetic processing. All functions of the processor 71 may be installed in the hardware, or configured using a programmable device.

The processor 71 controls each unit of the display device 6 by executing the control program 76 stored in the memory 75. The processor 71 includes a display control unit 72 and a filter 73. The display control unit 72 and the filter 73 are functional parts configured through a cooperation of hardware and software when the processor 71 executes the control program 76. The memory 75 includes a drawing image memory 77. The drawing image memory 77 is a logical or virtual storage region using a part of the storage region of the memory 75.

The display control unit 72 causes the DP communication unit 63 to receive the captured image transmitted by the projector 1. The display control unit 72 displays, on the display 61, the captured image received by the DP communication unit 63.

The display control unit 72 accepts the operation detected by the touch sensor 62. The display control unit 72 generates a drawing image on the basis of the accepted operation. The display control unit 72 stores the generated drawing image in the drawing image memory 77.

The display control unit 72 causes the display 61 to display the image stored in the drawing image memory 77. In addition, the display control unit 72 generates a transmission image including the image stored in the drawing image memory 77 and transmits the transmission image to the projector 1 with the DP communication unit 63.

When a captured image is received from the projector 1 in the state where the display control unit 72 causes the display 61 to display the image stored in the drawing image memory 77, the processor 71 executes the processing of the filter 73. The filter 73 performs filtering of the image stored in the drawing image memory 77 on the basis of the captured image received from the projector 1. Specifically, the filter 73 performs processing of removing the image included in the captured image received from the projector 1 from the image stored in the drawing image memory 77. The display control unit 72 displays, on the display 61, the image after the processing of the filter 73.

### 3. Configurations of Projection Unit and Image-Capturing Unit

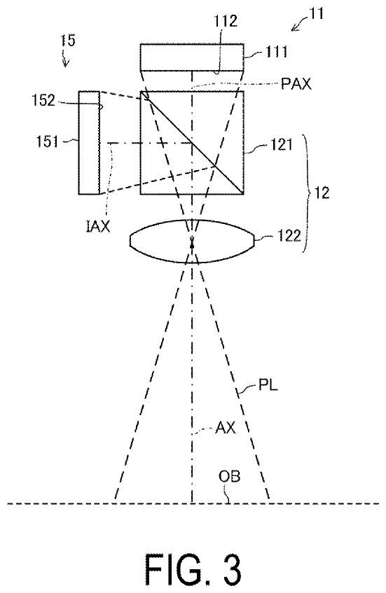

FIG. 3 is a schematic view illustrating an exemplary configuration of the projection unit 10 and the image-capturing unit 15.

The projection optical system 12 includes a separation optical element 121 and a projection lens 122. The optical axis of the image light PL projected by the projection lens 122 toward the projection target OB is denoted with the reference numeral AX. The optical axis AX is the center axis of the image light PL emitted to the projection target OB from the projection lens 122, and is a virtual axis passing through the optical center of the projection lens 122 and extending along the direction in which the image light PL is emitted from the projection lens 122.

The image light forming unit 11 includes a light-emitting device 111. In the light-emitting device 111, light-emitting elements are disposed side by side at a light-emitting surface 112. The light-emitting elements disposed at the light-emitting surface 112 includes a light-emitting element that emits red light, a light-emitting element that emits blue light, and a light-emitting element that emits green light. These light-emitting elements are disposed in a matrix, and thus the light-emitting device 111 emits the image light PL forming images from the light-emitting surface 112.

The light-emitting surface 112 faces the separation optical element 121. The image light PL emitted by the light-emitting surface 112 travels along the optical axis AX, enters the separation optical element 121, passes through the separation optical element 121, and impinges on the projection lens 122. The projection lens 122 irradiates the projection target OB with the image light PL transmitted through the separation optical element 121. The optical axis of the image light PL emitted by the light-emitting surface 112 is referred to as projection optical axis PAX. The projection optical axis PAX is the center axis of the image light PL emitted by the light-emitting device 111, and is a virtual axis extending perpendicular to the light-emitting surface 112 and passing through the center of the region where the light-emitting element is disposed at the light-emitting surface 112. In the configuration illustrated in FIG. 3, the projection optical axis PAX coincides with the optical axis AX. In other words, the light-emitting device 111 is disposed on the optical axis AX of the projection optical system 12.

The image-capturing unit 15 includes an imaging device 151. The imaging device 151 is disposed to face the separation optical element 121. In the imaging device 151, imaging elements are disposed side by side at an imaging surface 152 facing the separation optical element 121. With each imaging element disposed at the imaging surface 152 and receiving light incident from the separation optical element 121, the image-capturing unit 15 performs image-capturing. The imaging device 151 faces a surface different from that of the light-emitting device 111 in the separation optical element 121. Specifically, the light-emitting device 111 is disposed next to the separation optical element 121 in the direction along the optical axis AX. On the other hand, the imaging device 151 faces the separation optical element 121 at 90 degrees with respect to the optical axis AX.

The separation optical element 121 allows the light emitted by the light-emitting device 111 to pass through it and impinge on the projection lens 122, whereas the separation optical element 121 reflects, toward the imaging device 151, the light incident on the separation optical element 121 from the projection lens 122. A polarization separation element may be used as the separation optical element 121, for example. The separation optical element 121 may be composed of a dichroic mirror or a dichroic prism.

The optical axis of the light reflected by the separation optical element 121 toward the imaging device 151 is denoted with the reference numeral IAX. An image-capturing optical axis IAX is the center axis of the light travelling from the separation optical element 121 toward the imaging device 151, and is the axis of the light that is received by the imaging device 151 at the imaging surface 152. The image-capturing optical axis IAX is a virtual axis perpendicular to the imaging surface 152. In other words, the imaging device 151 is disposed such that the center of the imaging surface 152 coincides with the image-capturing optical axis IAX.

The image-capturing optical axis IAX coincides with the optical axis AX until the reflection inside the separation optical element 121.

That is, in the region closer to the projection target OB than the projection optical system 12, the projection optical axis PAX of the image light PL emitted by the image light forming unit 11 and the image-capturing optical axis IAX of the light received by the image-capturing unit 15 coincide with each other. In this manner, the projection unit 10 and the image-capturing unit 15 are optically coaxial. That is, the projection unit 10 and the image-capturing unit 15 coaxially performs projection and image-capturing of the image light PL.

FIG. 3 is a schematic view, and the projection unit 10, the projection optical system 12 and the image-capturing unit 15 may include members not illustrated in FIG. 3. For example, the projection optical system 12 may include optical elements different from the separation optical element 121 and the projection lens 122. For example, the projection optical system 12 may include a light guiding element between the separation optical element 121 and the projection lens 122. It is possible to provide a polarization separation element and a polarization conversion element between the light-emitting device 111 and the separation optical element 121 so as to adjust the polarization of the image light PL incident on the separation optical element 121.

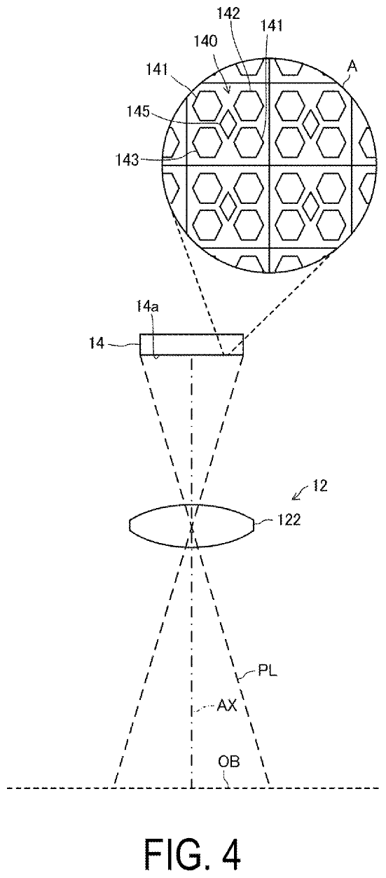

FIG. 4 is a schematic view illustrating another exemplary configuration of the projection unit 10 and the image-capturing unit 15.

This exemplary configuration uses a light receiving/emitting device 14 with the projection unit 10 and the image-capturing unit 15 integrated with each other. In the example of FIG. 4, the projection optical system 12 does not include the separation optical element 121. The projection lens 122 of FIG. 4 may be identical to the projection lens 122 exemplified in FIG. 3, or may have a different configuration.

The light receiving/emitting device 14 is disposed on the optical axis AX of the projection lens 122. The light receiving/emitting device 14 includes a light-emitting element and a light reception element at a light receiving/emitting surface 14a facing the projection lens 122. Specifically, as illustrated in an enlarged manner in a circle A in FIG. 4, a blue emission element 141, a red emission element 142, a green light-emitting element 143, and an imaging element 145 are disposed at the light receiving/emitting surface 14a.

The blue emission element 141, the red emission element 142, and the green light-emitting element 143 are composed of LEDs or OLEDs, for example. The blue emission element 141 is an element that emits light of the blue wavelength range, the red emission element 142 is an element that emits light of the red wavelength range, and the green light-emitting element 143 is an element that emits light of the green wavelength range. In the example illustrated in FIG. 4, two blue emission elements 141, one red emission element 142, one green light-emitting element 143, and one pixel region 140 are formed. The pixel region 140 is a region that forms one pixel included in the image formed by the light receiving/emitting device 14. The pixel region 140 forms the color of one pixel with two blue emission elements 141, one red emission element 142 and one green light-emitting element 143.

In the light receiving/emitting surface 14a, one the imaging element 145 is included in one pixel region 140. The imaging element 145 is an element composed of CMOS or CCD, and receives light incident on the light receiving/emitting surface 14a. The image-capturing unit 15 performs image-capturing through light reception at the imaging element 145.

In this manner, the light receiving/emitting device 14 functions as the image light forming unit 11 for forming the image light PL and the image-capturing unit 15 for performing image-capturing. The optical axis of the image light PL emitted by the light receiving/emitting device 14 is the optical axis AX, and the image-capturing unit 15 performs image-capturing with light that is incident along the optical axis AX. In the configuration illustrated in FIG. 4, as with the configuration illustrated in FIG. 3, the projection unit 10 and the image-capturing unit 15 are optically coaxial, and the projection unit 10 and the image-capturing unit 15 perform projection and image-capturing on the same axis.

### 4. Operation of Projection System

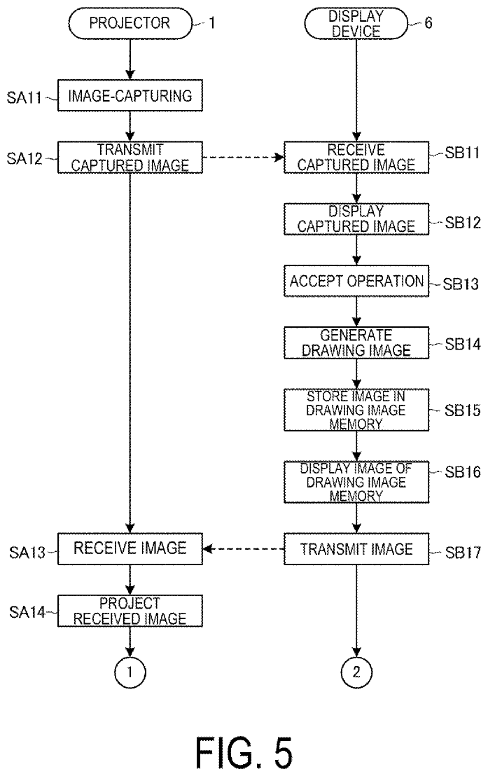

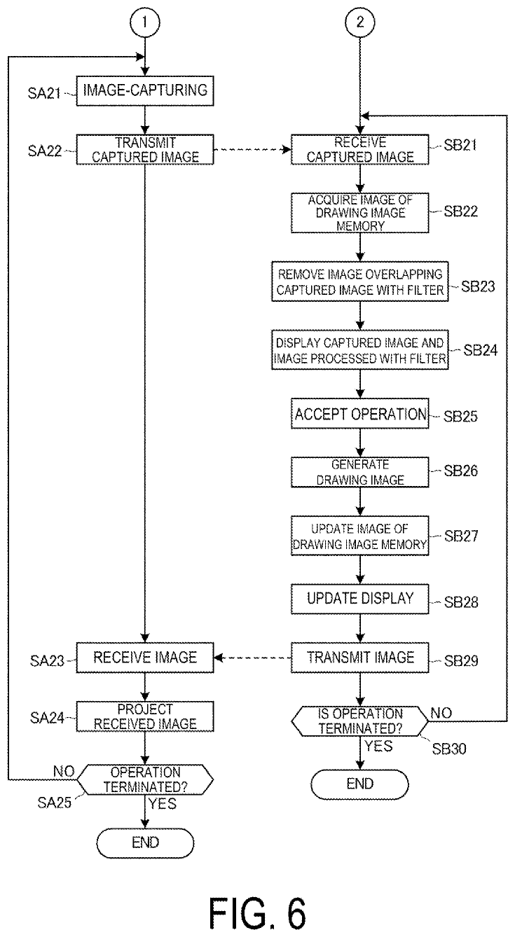

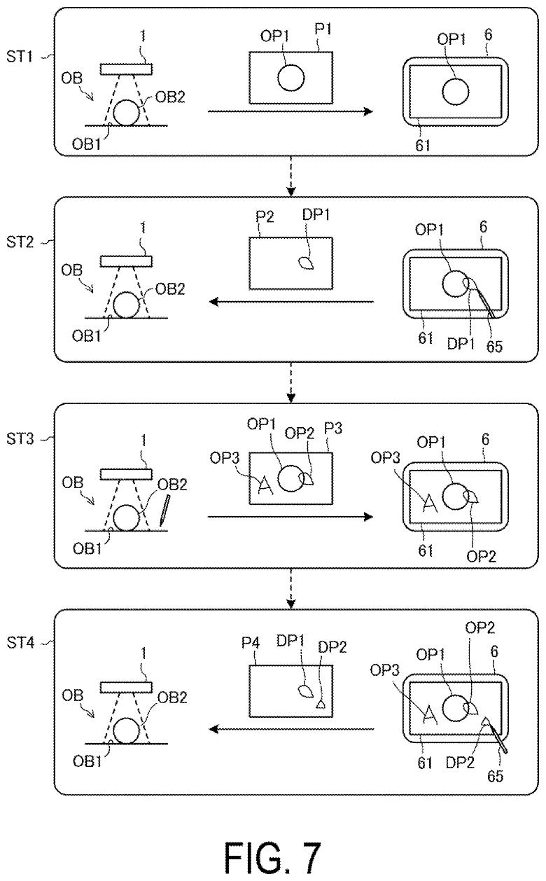

FIGS. 5 and 6 are sequence diagrams illustrating an operation of the projection system 100. FIG. 7 is a schematic view of an operation of the projection system 100. An operation of the projection system 100 is described below with reference to these drawings.

In FIGS. 5 and 6, the PJ control unit 20 performs the processing of steps SA11 to SA14 and SA21 to SA25, and the DP control unit 70 performs the processing of steps SB11 to SB17 and SB21 to SB30.

At step SA11, the projector 1 captures the range including the projection target OB. At step SA12, the projector 1 transmits the captured image to the display device 6.

At step SB11, the display device 6 receives the captured image transmitted from the projector 1. At step SB12, the display device 6 displays the received captured image on the display 61.

Here, when the operation of the instructing member 65 is detected, the display device 6 accepts this operation at step SB13. At step SB14, the display device 6 generates a drawing image on the basis of the operation accepted at step SB13. For example, the display device 6 draws curved lines and straight lines along the movement trajectory of the instructing member 65.

At step SB15, the display device 6 stores the drawing image generated at step SB14 in the drawing image memory 77.

At step SB16, the display device 6 displays the image stored in the drawing image memory 77 on the display 61. To be more specific, the display device 6 generates a composite image by superimposing the image stored in the drawing image memory 77 on the captured image displayed in step SB12, and displays the composite image on the display 61.

In step SB17, the display device 6 generates a transmission image including the image stored in the drawing image memory 77, transmits the transmission image to the projector 1, and proceeds to step SB21.

The projector 1 receives the image transmitted by the display device 6 at step SA13. At step SA14, the projector 1 projects the received image onto the projection target OB with the projection unit 10, and proceeds to step SA21.

Steps SA11 to SA14 and steps SB11 to SB17 illustrated in FIG. 5 are operations from the start of the operation of the projection system 100 to the first transmission of the transmission image from the display device 6 to the projector 1. On the other hand, steps SA21 to SA25 and steps SB21 to SB30 of FIG. 6 are operations of the projection system 100 after the first transmission of the transmission image from the display device 6 to the projector 1.

At step SA21, the projector 1 captures the range including the projection target OB. At step SA21, the projector 1 performs image-capturing with the image-capturing unit 15 in the state where the projection unit 10 projects an image on the basis of the transmission image. In view of this, the image projected by the projection unit 10 is shown in the captured image of the image-capturing unit 15. At step SA22, the projector 1 transmits the captured image to the display device 6.

At step SB21, the display device 6 receives the captured image transmitted from the projector 1. At step SB22, the display device 6 acquires the image stored in the drawing image memory 77. Specifically, the display device 6 acquires the image stored in the drawing image memory 77 as the processing target of the filter 73.

With the filter 73, the display device 6 performs the filtering based on the captured image received at step SB21 on the image acquired at step SB22. In this filtering, the image overlapping the captured image is removed from the image stored in the drawing image memory 77.

The filter 73 superimposes the image stored in the drawing image memory 77 and the captured image, removes the overlapping portion of the image stored in the drawing image memory 77 and the captured image, and outputs it, for example.

In addition, for example, the filter 73 may perform processing of recognizing an image object included in the image stored in the drawing image memory 77 and an image object included in the captured image. The image object is a single image group such as a diagram and letters. For example, the filter 73 removes the background from the image stored in the drawing image memory 77, and extracts an image object included in the image from which the background has been removed. In addition, the filter 73 removes the background from the captured image, and extracts an image object included in the image from which the background has been removed. The filter 73 identifies the matching image object by comparing the image object extracted from the image stored in the drawing image memory 77 and the image object extracted from the captured image. The filter 73 removes the identified image object from the image stored in the drawing image memory 77, and outputs the image after the removal.

In the present embodiment, the object to be filtered by the filter 73 is the image acquired from the drawing image memory 77 at step SB22. Therefore, when the filter 73 performs the filtering, the image stored in the drawing image memory 77 is not modified. As another example, the image filtered and output by the filter 73 may be stored in the drawing image memory 77. In this case, the image stored in the drawing image memory 77 is updated on the basis of the result of the filtering of the filter 73.

The image that overlaps the captured image and the image stored in the drawing image memory 77 include images with completely matching size, position, and shape. In addition, the filter 73 may remove an image with a size, position or shape different from that of the image included in the captured image from the image stored in the drawing image memory 77. In this case, the DP control unit 70 may have a threshold value defining the acceptable range for the difference in size, position, and shape of the image. For example, when the difference in size, position, and shape of the image is smaller than the threshold value, it is possible to determine that the image is overlapping. In addition, the filter 73 may perform processing of removing the image on the basis of whether the image color matches.

The display device 6 displays the image output by the filter 73 and the captured image received at step SB21 on the display 61 at step SB24. Specifically, at step SB24, the display device 6 updates the image already displayed on the display 61.

When an operation with the instructing member 65 is detected, the display device 6 accepts this operation at step SB25. At step SB26, the display device 6 generates a drawing image on the basis of the operation accepted at step SB25. At step SB27, the display device 6 updates the image stored in the drawing image memory 77 on the basis of the drawing image generated at step S26. For example, the display device 6 combines the drawing image generated at step SB26 with the image stored in the drawing image memory 77 in a superimposed manner, and stores the composite image in the drawing image memory 77.

At step SB28, the display device 6 updates the display of the display 61 on the basis of the image stored in the drawing image memory 77 after the update. At step SB28, the display device 6 may perform filtering with the filter 73 as at step SB23, and the image output by the filter 73 after the filtering processing may be displayed on the display 61. In addition, the display device 6 may additionally display, on the display 61, the image object newly stored in the drawing image memory 77 at step SB27.

At step SB29, the display device 6 generates a transmission image including the image stored in the drawing image memory 77 and transmits the transmission image to the projector 1.

At step SA23, the projector 1 receives the image transmitted by the display device 6. At step SA24, the projector 1 projects the received image onto the projection target OB with the projection unit 10.

At step SA25, the projector 1 determines whether the operation has been completed. The projector 1 terminates this processing when it is determined that the operation is to be completed (step SA25; YES) such as when an instruction operation to end the operation is detected by the input interface 33. When it is determined that the operation is not to be completed (step SA25; NO), the projector 1 returns the processing to step SA21.

After transmitting the transmission image to the projector 1, the display device 6 determines whether the operation is to be completed at step SB30. The display device 6 terminates this processing when it is determined that the operation is to be completed (step SB30; YES) such as when an instruction operation to end the operation is detected at the touch sensor 62. When it is determined that the operation is not to be completed (step SB30; NO), the display device 6 returns the processing to step SB21.

FIG. 7 illustrates operation states ST1, ST2, ST3 and ST4 of the projection system 100.

In the projection target OB of the projector 1, an object OB2 is placed on a plane OB1. At the plane OB1, paper or the like is placed, and the user using the projector 1 can write a diagram and letters on the plane OB1 with a writing tool.

In the state ST1, the projector 1 transmits, to the display device 6, a captured image P1 obtained by capturing the plane OB1 and the object OB2. The captured image P1 includes an object image OP1, which is a captured image of the object OB2. The display device 6 receives the captured image P1 and displays the captured image P1 on the display 61. The display 61 displays the object image OP1.

The state ST2 is a state where an operation is performed with the instructing member 65 in the display device 6. The display device 6 draws the drawing image DP1 on the basis of the operation of the instructing member 65. As described above with reference to FIG. 5, the display device 6 stores the drawing image DP1 in the drawing image memory 77. The display device 6 generates a transmission image P2 including the drawing image DP1 stored in the drawing image memory 77. The display device 6 transmits the transmission image P2 to the projector 1, and the projector 1 receives the transmission image P2 and projects the transmission image P2 onto the projection target OB.

The state ST3 is a state where a diagram is written on the plane OB1 with a writing tool in the projector 1. The projector 1 transmits a captured image P3 obtained by capturing the projection target OB to the display device 6. The captured image P3 includes the object image OP1 as the image of the object OB2, an object image OP2, and an object image OP3. The object image OP2 is an image obtained by capturing, with the image-capturing unit 15, the drawing image DP1 projected by the projection unit 10 on the projection target OB. The object image OP3 is an image obtained by capturing, with the image-capturing unit 15, the diagram written with a writing tool on the plane OB1 in the projector 1.

The display device 6 receives the captured image P3. Here, the display device 6 executes filtering with the filter 73. In the state ST3, the drawing image memory 77 stores the drawing image DP1. The filter 73 filters the drawing image DP1 stored in the drawing image memory 77 on the basis of the captured image P3. Specifically, among the images stored in the drawing image memory 77, images overlapping the object images OP1, OP2 and OP3 included in the captured image P3 are removed. Through this process, the filter 73 outputs the image obtained by removing the drawing image DP1 from the image stored in the drawing image memory 77. Then, the display device 6 displays the image output by the filter 73 and the captured image P3 in a superimposed manner on the display 61. As a result of these processes, the object images OP1, OP2 and OP3 included in the captured image P3 are displayed on the display 61. The object image OP2 is the same as the drawing image DP1 displayed on the display 61 in the state ST2. However, the drawing image DP1 displayed in the state ST2 is the image stored in the drawing image memory 77, and the object image OP2 displayed in the state ST3 is the image included in the captured image P3.

The drawing image DP1 and the object image OP2 may not be exactly the same image. The object image OP2 is an image obtained by capturing, with the image-capturing unit 15, the image projected onto the projection target OB by the projection unit 10 on the basis of the transmission image P2. As such, due to various factors, the object image OP2 may not be the same image as the drawing image DP1. Examples of such factors include unevenness in brightness of the plane OB1 due to ambient light, the shadow of the object OB2 due to ambient light, the color of the plane OB1, and the irregularity of the plane OB1.

If the drawing image DP1 and the object image OP2 are displayed in a superimposed manner on the display 61 in the case where the drawing image DP1 and the object image OP2 do not completely coincide with each other, the display of the display 61 may be disturbed. For example, the line making up the object image OP2 and the line making up the drawing image DP1 may be displayed as double lines. In addition, for example, the line making up the object image OP2 and the line making up the drawing image DP1 may be displayed in a state like interference fringes. Such displays become factors that lead to reduction of the display quality and reduction of the visibility of the object image OP2 and the drawing image DP1.

In particular, in the case where a configuration in which the projection optical axis PAX of the projection unit 10 and the image-capturing optical axis IAX of the image-capturing unit 15 are the same axis, i.e., coaxial as illustrated in FIGS. 3 and 4 is employed, the difference in position and size between the object image OP2 and the drawing image DP1 is extremely small. As such, the phenomenon in which the line making up the object image OP2 and the line making up the drawing image DP1 are displayed in a state like interference fringes easily occurs.

In the projection system 100 of this embodiment, the display device 6 performs filtering of the filter 73 on the image stored in the drawing image memory 77 on the basis of the captured image of the projector 1. For example, in the case where the captured image P3 including the object image OP2 corresponding to the drawing image DP1 is received during the display of the drawing image DP1 on the display 61, the display device 6 displays the captured image P3 and stops the display of the drawing image DP1. In this manner, the drawing image DP1 and the object image OP2 do not displayed in a superimposed manner, and the reduction of the display quality of the display 61 can be prevented.

The state ST4 is the state where an operation is performed with the instructing member 65 at the display device 6. The display device 6 draws the drawing image DP2 on the basis of the operation of the instructing member 65. The display device 6 updates the image of the drawing image memory 77 on the basis of the drawing image DP2. In this manner, the drawing image memory 77 stores a composite image of the drawing image DP1 and the drawing image DP2. The display device 6 transmits, to the projector 1, a transmission image P4 including the image stored in the drawing image memory 77 after the update. The transmission image P4 includes the drawing image DP1 and the drawing image DP2. The projector 1 receives the transmission image P4, and projects the transmission image P4 to the projection target OB with the projection unit 10.

### 5. Operational Effects of Embodiment

As described above, the projection system 100 described in the embodiment includes the projector 1 and the display device 6. The projector 1 includes the PJ communication unit 42 that communicates with the display device 6, the projection unit 10 that projects an image onto the projection target OB, and the image-capturing unit 15 that captures the range including the projection target OB. The projector 1 projects the image received by the PJ communication unit 42 with the projection unit 10, and transmits the captured image of the image-capturing unit 15 with the PJ communication unit 42. The display device 6 includes the DP communication unit 63 that communicates with the projector 1, the display 61 that displays an image, and the touch sensor 62 that accepts drawing operation. The display device 6 generates a drawing image on the basis of a drawing operation accepted by the touch sensor 62, and displays the drawing image on the display 61. The display device 6 transmits the drawing image with the DP communication unit 63, and receives the captured image with the DP communication unit 63. The display device 6 performs processing of removing the image overlapping the captured image received from the projector 1 from the drawing image displayed on the display 61, and updates the display of the display 61 on the basis of the captured image and the processed image.

With the projector 1, the control method of the projection system 100 receives an image from the display device 6, projects the received image onto the projection target OB, captures the range including the projection target OB, and transmits the captured image to the display device 6. With the display device 6, this control method generates a drawing image on the basis of a drawing operation, displays the drawing image on the display 61, transmits the drawing image to the projector 1, and receives the captured image of the projector 1. In addition, processing of removing an image overlapping the captured image received from the projector 1 from the drawing image displayed on the display 61 is performed, and the display of the display 61 is updated on the basis of the captured image and the processed image.

In this manner, the state of the projection target OB of the projector 1 can be displayed by the display device 6, and the image drawn on the basis of the operation of the display device 6 can be projected by the projector 1. In this manner, the user using the projector 1 and the user using the display device 6 can share the state of the projection target OB of the projector 1 and the details of the drawing operation for the display device 6.

The display device 6 performs the processing of removing the image overlapping the captured image received from the projector 1 from the drawing image with the filter 73.

In this manner, the phenomenon in which the captured image received by the display device 6 from the projector 1 and the drawing image generated by the display device 6 overlap each other in the display 61 can be eliminated by using the filter 73. Thus, the reduction of the display quality of the display 61 can be more reliably prevented.

The display device 6 includes the drawing image memory 77 that stores images. When a drawing image is generated on the basis of a drawing operation, the display device 6 stores the drawing image in the drawing image memory 77. The display device 6 performs the processing of removing the image overlapping the captured image received from the projector 1 from the image stored in the drawing image memory 77 with the filter 73, and displays the captured image and the image after the processing on the display 61.

In this manner, when a drawing operation is performed at the display device 6, the drawing image can be immediately displayed on the display 61. In this manner, the phenomenon in which the captured image received by the display device 6 from the projector 1 and the drawing image generated by the display device 6 overlap each other in the display 61 can be eliminated by using the filter 73, and the operability of the drawing operation can be improved.

Each time the display device 6 generates a drawing image on the basis of a drawing operation, the display device 6 combines the generated drawing image with the image stored in the drawing image memory 77, and updates the image stored in the drawing image memory 77.

In this manner, the display device 6 can store a plurality of drawing images in the drawing image memory 77. In this manner, the display device 6 can transmit, to the projector 1, a plurality of drawing images generated at different timings on the basis of the operation of the instructing member 65. Thus, the reduction of the display quality due to overlap of a drawing image and a captured image corresponding to the drawing image can be prevented, and the drawing image drawn through multiple operations can be shared between the projector 1 and the display device 6.

In the projector 1, the projection unit 10 includes the image light forming unit 11 that forms image light and the projection optical system 12 that projects the image light toward the projection target OB. The image-capturing unit 15 includes the imaging device 151 that receives light incident through the projection optical system 12.

In this manner, in a configuration in which the projection of the projection unit 10 and image-capturing of the image-capturing unit 15 use the common projection optical system 12, the captured image of the projector 1 and the drawing image generated by the display device 6 can be displayed on the display 61 with favorable quality. In a configuration in which a small difference is tends to be caused between the captured image and the drawing image due to the use of the projection optical system 12 shared for the projection and image-capturing by the projector 1, the reduction of the display quality of the display 61 due to the image difference can be prevented.

### 6. Other Embodiments

The above-described embodiment is a favorable embodiment of the present disclosure. However, this is not limitative, and various variations may be implemented within the scope that does not depart from the gist of the disclosure.

The configurations illustrated in FIGS. 3 and 4 are examples, and the configurations of the projection unit 10 and the image-capturing unit 15 provided in the projector 1 may be changed as desired. For example, the image-capturing unit 15 may be configured as a member separated from the projector 1.

The configurations of the projector 1 and the display device 6 illustrated in FIG. 2 are functional configurations, and their specific mounting forms are not limited. Specifically, it is not necessary to mount hardware corresponding to respective functional parts, and it is possible to adopt a configuration in which the functions of a plurality of functional parts are implemented when a single processor performs a program. In addition, in the above-mentioned embodiment and modifications, apart of the function implemented by software may be implemented by hardware, and a part of the function implemented by hardware may be implemented by software.

In addition, the unit of the processing of the sequence diagram illustrated in FIGS. 5 and 6 is divided in accordance with the content of the main processing for the purpose of easy understanding of the operation of each device of the projection system 100, and the present disclosure is not limited to the names and the divisions of the units of processing. In accordance with the content of the processing, the processing implemented by each device may be further divided into more units of processing, and may be divided such that one unit of processing further includes more processes.

The control program 26 may be recorded in a recording medium recorded such that it is readable by the projector 1, for example. As the recording medium, magnetic and optical recording media or semiconductor memory devices may be used. Specifics examples include portable or fixed recording media such as flexible disk and optical disk-type storage media, magneto-optical disk recording media, and semiconductor storage devices. In addition, it is possible to adopt a configuration in which these programs are stored in a server device and the like, and the programs are downloaded from the server device as necessary. The same applies to the control program 76.

What is claimed is:

1. A projection system comprising:
a projector including a projector communication unit, a projection unit configured to project an image to a projection target, an image-capturing unit configured to capture a range including the projection target, and a projector control unit; and
a display device including a display communication unit configured to communicate with the projector communication unit, a display configured to display an image, an operation unit configured to accept a drawing operation, and a display control unit, wherein
the projector control unit projects, using the projection unit, an image received by the projector communication unit,
the projector control unit transmits, using the projector communication unit, a captured image captured by the image-capturing unit,
the display control unit generates a drawing image based on the drawing operation accepted by the operation unit,
the display control unit displays the drawing image on the display,
the display control unit transmits, using the display communication unit, the drawing image to the projector communication unit,
the display control unit receives the captured image using the display communication unit, and
the display control unit performs processing of removing, from the drawing image displayed on the display, an image overlapping the captured image received from the projector communication unit, and updates display on the display based on the captured image and the processed image.

2. The projection system according to claim 1, wherein the display control unit performs processing of removing, from the drawing image by using a filter, an image overlapping the captured image received from the projector communication unit.

3. The projection system according to claim 2, wherein
the display device includes a drawing image memory configured to store an image,
when the drawing image is generated based on the drawing operation, the display device stores the drawing image in the drawing image memory, and
the display device performs processing of removing, from the image stored in the drawing image memory by using the filter, an image overlapping the captured image received from the projector communication unit, and displays, on the display, the captured image and the processed image.

4. The projection system according to claim 3, wherein every time the drawing image is generated based on the drawing operation, the display control unit updates the image stored in the drawing image memory by combining the drawing image generated and the image stored in the drawing image memory.

5. The projection system according to claim 1, wherein
the projection unit includes an image light forming unit configured to form image light, and a projection optical system configured to project the image light toward the projection target, and
the image-capturing unit includes an imaging device configured to receive light incident through the projection optical system.

6. A method of controlling a projection system that includes a projector and a display device,
the method comprising, by the projector:
receiving an image from the display device;
projecting the received image to a projection target;
capturing a range including the projection target; and
transmitting a captured image to the display device,
the method comprising, by the display device:
generating a drawing image based on a drawing operation;
displaying the drawing image on a display;
transmitting the drawing image to the projector;
receiving the captured image from the projector; and
performing processing of removing, from the drawing image displayed on the display, an image overlapping the captured image received from the projector, to update display on the display based on the captured image and the processed image.
